(19) United States
(12) Patent Application Publication
(10) Pub. No.: US 2025/0211147 A1
(43) Pub. Date: Jun. 26, 2025

(54) MOTOR DRIVE DEVICE, REFRIGERATION CYCLE APPARATUS, AND REFRIGERATION CYCLE SYSTEM

(71) Applicant: Mitsubishi Electric Corporation, Tokyo (JP)

(72) Inventors: Kazunori SAKANOBE, Tokyo (JP); Kenta YUASA, Tokyo (JP); Yasuhiko WADA, Tokyo (JP)

(21) Appl. No.: 18/848,023

(22) PCT Filed: May 23, 2022
(86) PCT No.: PCT/JP2022/021051

§ 371 Date: Sep. 17, 2024

(51) Int. Cl. H02P 21/05; F25B 49/02; H02P 21/18; H02P 21/20; H02P 21/22

(52) U.S. Cl. CPC H02P 21/05; F25B 49/022; H02P 21/18; H02P 21/20; H02P 21/22; F25B 2600/021

(57) ABSTRACT

A motor drive device performs a feedback control of a motor based on a motor current that is a current flowing in the motor. The motor drive device includes: an index value calculation unit configured to calculate power or a work rate of the motor as an index value for use in determining whether an abnormality occurs in the motor or not based on the motor current and a control parameter used in the feedback control; a filter unit configured to perform a filtering process to extract an abnormal component by removing a component that is in a normal operating state, from the index value calculated by the index value calculation unit; and a diagnosis unit configured to conduct a diagnosis of the motor regarding an abnormality or degradation thereof based on the abnormal component of the index value.

### TECHNICAL FIELD

The present disclosure relates to a motor drive device that controls the drive of a motor, and also relates to a refrigeration cycle apparatus and a refrigeration cycle system.

### BACKGROUND ART

In an existing proposed method of detecting an abnormality in a bearing of a compressor, when the change rate of current for driving a motor of the compressor exceeds a reference value, it is determined that an abnormality condition is satisfied (see, for example, Patent Literature 1). A method disclosed in Patent Literature 1 is a method of determining whether an abnormality occurs or not based on a comparison between the change rate of a motor current and a predetermined reference value.

### CITATION LIST

### Patent Literature

Patent Literature 1: Japanese Unexamined Patent Application Publication No. 2019-218928

### SUMMARY OF INVENTION

### Technical Problem

However, in the method disclosed in Patent Literature 1, the change rate of current that is to be subjected to the above determination changes depending on the operating frequency of the compressor, the current advance angle of the motor, or other factors. Therefore, in the method disclosed in Patent Literature 1, there is a likelihood that not only a current change caused by an abnormality in the bearing, but also a current change under normal control of the compressor will be determined as an abnormality. Thus, in the method disclosed in Patent Literature 1, there is a possibility that the accuracy of detecting an abnormality that occurs in the motor will be insufficient.

The present disclosure is applied to solve the above problem, and relates to a motor drive device that can accurately detect an abnormal state of a motor, and also to a refrigeration cycle apparatus and a refrigeration cycle system.

### Solution to Problem

A motor drive device according to one embodiment of the present disclosure is a motor drive device that performs a feedback control of a motor based on a motor current that is a current flowing in the motor. The motor drive device includes: an index value calculation unit configured to calculate power or a work rate of the motor as an index value for use in determining whether an abnormality occurs in the motor or not based on the motor current and a control parameter used in the feedback control; a filter unit configured to perform a filtering process to extract an abnormal component by removing a component that is in a normal operating state, from the index value calculated by the index value calculation unit; and a diagnosis unit configured to conduct a diagnosis of the motor regarding an abnormality or degradation thereof based on the abnormal component of the index value.

A refrigeration cycle apparatus according to another embodiment of the present disclosure includes: a refrigerant circuit including a compressor in which a motor is provided; and the motor drive device described above, the motor drive device being configured to drive the motor.

A refrigeration cycle system according to still another embodiment of the present disclosure includes: a refrigerant circuit including a compressor in which a motor is provided; a power converter including an inverter configured to supply power to the motor; a voltage command calculation unit configured to perform a feedback control of the motor through the inverter, based on a motor current that is a current flowing in the motor; an index value calculation unit configured to calculate power or a work rate of the motor as an index value for use in determining whether an abnormality occurs in the motor or not based on the motor current and a control parameter used in the feedback control; a filter unit configured to perform a filtering process to extract an abnormal component by removing a component in a normal operating state from the index value calculated by the index value calculation unit; and a diagnosis unit configured to conduct a diagnosis of the motor regarding an abnormality or degradation thereof based on the abnormal component of the index value.

### Advantageous Effects of Invention

According to the embodiments of the present disclosure, the motor is diagnosed regarding an abnormality or degradation thereof based on the abnormal component that is obtained after removing a component in a normal operating state of the motor from the power or the work rate of the motor as an index value that indicates an abnormality that occurs in the motor. Since a component corresponding to a change associated with the control for the motor is removed from a monitoring value of the motor, it is possible to quantitatively know whether an abnormality occurs in the motor or not and the degree of degradation of the motor. As a result, it is possible to accurately detect an abnormal state of the motor.

### BRIEF DESCRIPTION OF DRAWINGS

FIG. 1 illustrates a configuration example of a refrigeration cycle apparatus including a motor drive device according to Embodiment 1.

FIG. 2 illustrates a configuration example of a power converter as illustrated in FIG. 1.

FIG. 3 is a schematic configuration diagram illustrating a configuration example of a compressor provided in the refrigeration cycle apparatus according to Embodiment 1.

FIG. 4 is a functional block diagram illustrating a configuration example of a controller provided in the motor drive device according to Embodiment 1.

FIG. 5 illustrates an example of a current waveform in the case where an abnormality occurs in a motor.

FIG. 6 is a functional block diagram of an abnormality-index value extraction unit as illustrated in FIG. 4.

FIG. 7 is a hardware configuration diagram illustrating a configuration example of the controller as illustrated in FIG. 4.

FIG. 8 is a hardware configuration diagram illustrating another configuration example of the controller as illustrated in FIG. 4.

FIG. 9 is a block diagram illustrating a configuration example of a remote control.

FIG. 10 is a flowchart indicating a procedure for an abnormal power-amount extracting method according to Embodiment 1.

FIG. 11 illustrates an example of the results of processes of steps S101 to S103 indicated in FIG. 10.

FIG. 12 is a functional block diagram illustrating another configuration example of an abnormality-index value extraction unit provided in the motor drive device according to Embodiment 1.

FIG. 13 is a functional block diagram illustrating a configuration example of a controller provided in a motor drive device according to Embodiment 2.

FIG. 14 is a functional block diagram illustrating an abnormality-index value extraction unit as illustrated in FIG. 13.

FIG. 15 illustrates a configuration example of a refrigeration cycle system including having the refrigeration cycle apparatus according to Embodiment 1.

### DESCRIPTION OF EMBODIMENTS

### Embodiment 1

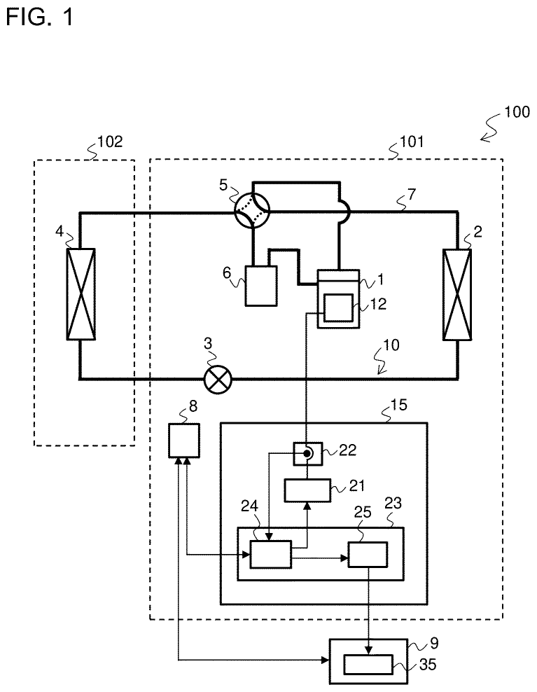

A configuration of a motor drive device according to Embodiment 1 will be described below. FIG. 1 illustrates a configuration example of a refrigeration cycle apparatus including the motor drive device according to Embodiment 1. As illustrated in FIG. 1, a refrigeration cycle apparatus 100 includes a heat-source-side unit 101, a load-side unit 102, and a remote control 9.

The heat-source-side unit 101 includes a compressor 1, a heat-source-side heat exchanger 2, an expansion device 3, a four-way valve 5, and an accumulator 6. The load-side unit 102 includes a load-side heat exchanger 4. The compressor 1, the heat-source-side heat exchanger 2, the expansion device 3, and the load-side heat exchanger 4 are connected by refrigerant pipes 7, whereby a refrigerant circuit 10 is formed in which refrigerant circulates. The following description concerning Embodiment 1 is made with respect to the case where the refrigeration cycle apparatus 100 is an air-conditioning apparatus. However, the refrigeration cycle apparatus 100 is not limited to the air-conditioning apparatus.

The compressor 1 sucks gas refrigerant, compressed the sucked gas refrigerant, and discharge the compressed gas refrigerant. The compressor 1 is an inverter compressor whose capacity is variable. The expansion device 3 reduces the pressure of refrigerant and expands the refrigerant. The heat-source-side heat exchanger 2 and the load-side heat exchanger 4 cause heat exchange to be performed between the refrigerant and air. The heat-source-side heat exchanger 2 and the load-side heat exchanger 4 are, for example, fin-and-tube heat exchangers. The four-way valve 5 switches the flow direction of refrigerant that circulates in the refrigerant circuit 10, between plural flow directions of the refrigerant, according to the operating mode of the refrigeration cycle apparatus 100. When the operating mode is a heating mode, the four-way valve 5 causes refrigerant discharged from the compressor 1 to flow into the load-side heat exchanger 4. When the operating mode is a cooling mode, the four-way valve 5 causes the refrigerant discharged from the compressor 1 to flow into the heat-source-side heat exchanger 2. The accumulator 6 is connected to a refrigerant inlet side of the compressor 1. The accumulator 6 is a refrigerant circuit auxiliary device that prevents liquid refrigerant from being sucked into the compressor 1.

The heat-source-side unit 101 further includes a controller 8 that controls the refrigeration cycle of refrigerant that circulates in the refrigerant circuit 10, and a motor drive device 15 that drives the compressor 1. The motor drive device 15 is connected to a motor 12 provided in the compressor 1, by a wire. The motor 12 is, for example, a three-phase brushless DC motor. The motor drive device 15 includes a power converter 21 that supplies power to the motor 12 through the wire, a current sensor 22 that detects a motor current that is current flowing in the motor 12, and a controller 23 that controls driving of the motor 12. The current sensor 22 is provided at the wire connecting the power converter 21 and the motor 12.

The controller 8 is connected to the expansion device 3, the four-way valve 5, the controller 23, and the remote control 9 by signal lines (not illustrated). The remote control 9 is used by a user of the refrigeration cycle apparatus 100 to input, to the controller 8, for example, the operating mode of the refrigeration cycle apparatus 100 and a set temperature of an air-conditioning target space for the load-side unit 102. The controller 8 controls the four-way valve 5, the expansion device 3, and the compressor 1 in response to an instruction for, for example, the operating mode that is input from the user through the remote control 9. Specifically, the controller 8 determines a speed command value w* for the motor 12 that corresponds to the operating frequency of the compressor 1 in response to a user's input instruction, and transmits the speed command value w* to the controller 23.

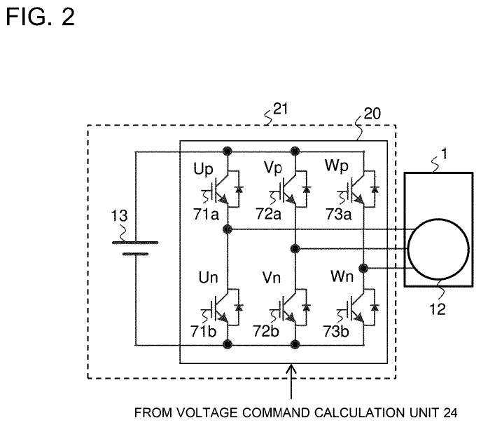

FIG. 2 illustrates a configuration example of the power converter as illustrated in FIG. 1. The power converter 21 includes a DC voltage source 13 and an inverter 20. The inverter 20 includes a plurality of switching elements 71a to 73a and 71b to 73b.

The switching element 71a is provided at a U-phase upper arm. The switching element 71b is provided at a U-phase lower arm. The switching element 72a is provided at a V-phase upper arm. The switching element 72b is provided at a V-phase lower arm. The switching element 73a is provided at a W-phase upper arm. The switching element 73b is provided at a W-phase lower arm. A DC voltage that is output from the DC voltage source 13 is applied between the U-phase upper and lower arms, between the V-phase upper and lower arms, and between the W-phase upper and lower arms. A connection point of the U-phase upper and lower arms, a connection point of the V-phase upper and lower arms, and a connection point of the W-phase upper and lower arms are connected to the motor 12.

The switching elements 71a to 73a and 71b to 73b in the inverter 20 perform switching operation in response to a control signal input from a voltage command calculation unit 24. The power converter 21 switches on and off the output from the DC voltage source 13 to generate an AC voltage having an arbitrary frequency and applies the AC voltage to the motor 12 to drive the motor 12.

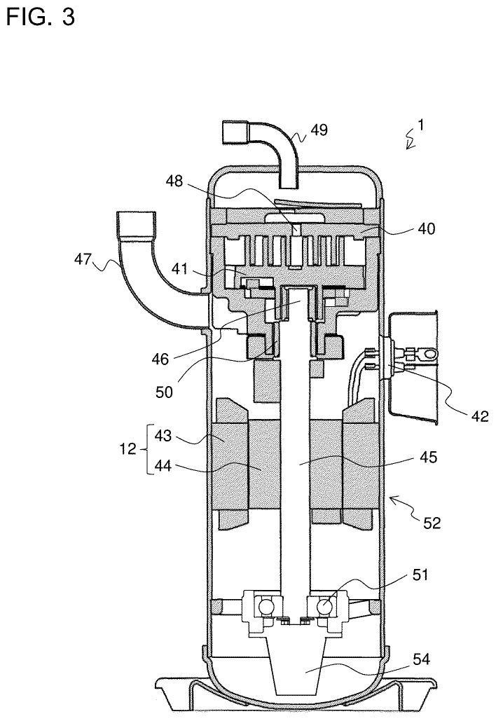

Next, a configuration of the compressor 1 will be described. Regarding Embodiment 1, the following description is made with respect to the case where the compressor 1 is a scroll compressor. However, the compressor 1 is not limited to the scroll compressor. FIG. 3 is a schematic configuration diagram illustrating a configuration example of the compressor provided in the refrigeration cycle apparatus according to Embodiment 1.

As illustrated in FIG. 3, the compressor 1 includes a compression mechanism including a stationary scroll 40 and an orbiting scroll 41, the motor 12 including a main shaft 45 as a rotational shaft, a suction pipe 47, a discharge pipe 49, and an oil pump 54. The compression mechanism, the motor 12, and the oil pump 54 are accommodated in a columnar hermetic container 52.

The motor 12 includes the main shaft 45, a stator 43, and a rotor 44. The main shaft 45 is attached to the rotor 44. The main shaft 45 is supported by two bearings, that is, a main bearing 50 and a sub-bearing 51. Specifically, an upper side of the main shaft 45 is supported by the main bearing 50, which is a slide bearing, and a lower side of the main shaft 45 is supported by the sub-bearing 51, which is a ball bearing. Since it is necessary to transfer the refrigerant, with the refrigerant circuit 10 hermetically sealed, rotary components such as the compression mechanism, the bearings, and the motor 12 are all exposed to the refrigerant.

The suction pipe 47 is provided on a lateral side of the hermetic container 52 to suck gas refrigerant from the accumulator 6. The discharge pipe 49 is provided on an upper side the hermetic container 52 to discharge gas refrigerant compressed by the compression mechanism to the four-way valve 5. On another side of the hermetic container 52, a power terminal 42 is provided to connect wires extending from the inverter 20 to windings of the motor 12. The oil pump 54 draws up lubricant oil that is stored at the bottom of the hermetic container 52, and transfers the lubricant oil to sliding parts including, for example, the compression mechanism and the bearing.

In the compression mechanism, the stationary scroll 40 and the orbiting scroll 41 are provided such that a stationary scroll body provided on a lower side of the stationary scroll 40 and an orbiting scroll body provided on an upper side of the orbiting scroll 41 are engaged with each other. Above the main shaft 45, a main shaft eccentric portion 46 is provided. The orbiting scroll 41 is attached to the main shaft 45, with the main shaft eccentric portion 46 interposed therebetween. On an upper side of the stationary scroll 40, a discharge port 48 through which compressed gas refrigerant flows toward the discharge pipe 49 is provided.

In the compressor 1, the orbiting scroll 41 is rotated by rotational power generated by the motor 12 to compress the gas refrigerant. The gas refrigerant is sucked from the suction pipe 47 into the compressor 1, compressed by the rotational movement of the orbiting scroll 41, and then discharged from the discharge pipe 49.

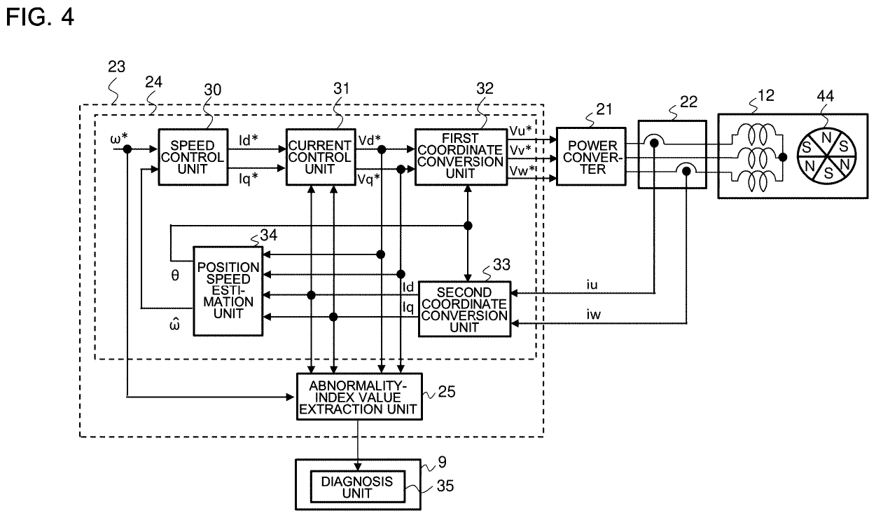

Next, a configuration of the controller 23 will be described. FIG. 4 is a functional block diagram illustrating a configuration example of the controller provided in the motor drive device according to Embodiment 1. The controller 23 is, for example, a microcomputer. As illustrated in FIG. 4, the controller 23 includes the voltage command calculation unit 24 and an abnormality-index value extraction unit 25.

The power converter 21 is connected to U-phase, V-phase, and W-phase windings of the motor 12. The voltage command calculation unit 24 performs a feedback control on the motor 12 through the inverter 20 as illustrated in FIG. 2 based on a motor current. The voltage command calculation unit 24 includes a speed control unit 30, a current control unit 31, a first coordinate conversion unit 32, a second coordinate conversion unit 33, and a position speed estimation unit 34. Although FIG. 4 illustrates an example in which a permanent magnet of the rotor 44 in the motor 12 has six magnetic poles, the number of magnetic poles is not limited to six.

The motor 12 in the compressor 1 is housed in the hermetic container 52 in which both the temperature and the pressure increase to a high level. It is therefore difficult that a sensor configured to detect the rotational position of the rotor 44 is provided in the hermetic container 52. In view of this point, the voltage command calculation unit 24 performs a position sensorless control on the motor 12 through the inverter 20 based on the motor current. FIG. 4 illustrates a configuration example of the voltage command calculation unit 24 in which the motor 12 is driven by a position sensorless vector control.

The current sensor 22 operates to detect a value for estimation of a driving state of the motor 12 and an operating state of the compressor 1. The current sensor 22 detects a U-phase motor current iu and a W-phase motor current iw in the motor 12, and transmits the motor currents iu and iw to the second coordinate conversion unit 33. Regarding Embodiment 1, the following description is made with respect to the case where the current sensor 22 detects the motor currents iu and iw; however, detection of the motor current is not limited to that of the above two kinds of current values. The current sensor 22 may detect a combination of any two of the motor currents iu and iw and a V-phase motor current iv, or may detect all of these three kinds of motor currents.

The second coordinate conversion unit 33 receives a phase θ indicating an estimated position from the position speed estimation unit 34, and receives the motor currents iu and iw from the current sensor 22. The phase θ is an estimated relative angle of the rotor 44 to the stator 43, and indicates an estimated position of the rotor 44 relative to a reference position. The second coordinate conversion unit 33 calculates the motor current iv from the equation “iu+iv+iw=0” and the motor currents iu and iw. While referring to the phase θ, the second coordinate conversion unit 33 converts the coordinates of the motor currents iu, iv, and iw to obtain a d-axis current Id and a q-axis current Iq. The second coordinate conversion unit 33 transmits the d-axis current Id and the q-axis current Iq to the current control unit 31, the position speed estimation unit 34, and the abnormality-index value extraction unit 25. The d-axis current Id and the q-axis current Iq are each an example of a control parameter used in the feedback control.

Based on the speed command value w* and an estimated speed ω\hat{ }received from the position speed estimation unit 34, the speed control unit 30 calculates an exciting current command value Id* and a torque current command value Iq*, such that the speed converges to the speed command value ω*. The speed control unit 30 transmits the exciting current command value Id* and the torque current command value Iq* to the current control unit 31. The exciting current command value Id* and the torque current command value Iq* are each an example of the control parameter used in the feedback control.

Based on the d-axis current Id and the q-axis current Iq received from the second coordinate conversion unit 33, and based on the exciting current command value Id* and the torque current command value Iq* received from the speed control unit 30, the current control unit 31 obtains voltage command values Vd* and Vq*, such that the currents converge to the current command values. The current control unit 31 transmits the voltage command values Vd* and Vq* to the first coordinate conversion unit 32, the position speed estimation unit 34, and the abnormality-index value extraction unit 25. The voltage command values Vd* and Vq* are each an example of the control parameter used in the feedback control.

The position speed estimation unit 34 uses the d-axis current Id and the q-axis current Iq received from the second coordinate conversion unit 33, and the voltage command values Vd* and Vq* received from the current control unit 31 to obtain the phase θ indicating an estimated position of the rotor 44 of the motor 12 and the estimated speed ω\hat{ }. The position speed estimation unit 34 transmits the phase θ indicating the estimated position to the first coordinate conversion unit 32 and the second coordinate conversion unit 33. The position speed estimation unit 34 transmits the estimated speed ω\hat{ } to the speed control unit 30. The phase θ indicating the estimated position of the rotor 44 and the estimated speed ω\hat{ } are each an example of the control parameter used in the feedback control.

When receiving the phase θ from the position speed estimation unit 34, and receiving the voltage command values Vd* and Vq* from the current control unit 31, the first coordinate conversion unit 32 converts the coordinates of the received voltage command values Vd* and Vq* to obtain voltage command values Vu*, Vv*, and Vw*. While referring to the phase θ, the first coordinate conversion unit 32 transmits the voltage command values Vu*, Vv*, and Vw* that are control signals for the inverter 20 to the power converter 21. The voltage command values Vu*, Vv*, and Vw* are each an example of the control parameter used in the feedback control.

The voltage command calculation unit 24 repeatedly makes the calculation described above, whereby the motor 12 is controlled in such a manner as to cause the rotation speed to coincide with the speed command value w*.

Next, principles of an abnormal power-amount extracting method for use by the abnormality-index value extraction unit 25 will be descried before referring to the configuration of the abnormality-index value extraction unit 25 in Embodiment 1. First of all, the following description is made with respect to the case where the compressor 1 is in a normal state and rotated at a constant operating frequency.

A load torque that is applied to the rotational shaft of the motor 12 in the compressor 1 is classified into a component depending on the compression of the gas refrigerant and a component depending on the pressure of the gas refrigerant. The compression of the gas refrigerant will be hereinafter “gas compression” and the pressure of the gas refrigerant will be referred to as “gas pressure.”

The torque component depending on the gas compression is generated by a series of operations of the compressor 1 per rotation, and is characterized by showing a pulsation waveform including a multiplication component of the rotational frequency. The series of operations means that suction of refrigerant gas, compression of the refrigerant gas and discharge of the refrigerant gas are sequentially performed. As the rotation speed of the compressor 1, values that fall within the range of 30 to 120 rps, are frequently applied. Therefore, the pulsation waveform is obtained as a frequency component of approximately 30 Hz or higher. That is, the pulsation waveform includes harmonics that are integer multiples of the rotational frequency of the compressor 1. In contrast, the gas pressure is changed by a room temperature, an outside air temperature, and an opening degree of the expansion device 3. This change of the gas pressure due to the above factors is slowly made, that is, it is made in a response time of several tens of seconds. Thus, a torque waveform generated due to the gas pressure is characterized by inclusion of a DC component and a very low frequency component.

Next, the following description is made with respect to the case where an abnormality that occurs in the refrigerant circuit 10 causes degradation or an abnormality in the compressor 1. Some parts of the refrigerant circuit 10, such as a joint portion of the pipe and movable portions of valves, continuously receive a mechanical stress. Due to this mechanical stress, a piece of a component of a refrigerant device may fall off the component. This piece is circulated in the refrigerant circuit 10 by the flow of the refrigerant. Since the refrigerant circuit 10 is a closed circuit, the piece remains as foreign material without being let out from the refrigerant circuit 10, and may continuously degrade the compressor 1.

The place where the foreign material is generated is not limited to a joint portion of the refrigerant pipe 7 or movable portions of the valves. For example, the foreign material may be generated in the compressor 1. The sliding parts in the compressor 1, which is represented by the main bearing 50, are normally supplied with lubricant oil sucked up by the oil pump 54. However, if the concentration of the oil lowers for some reason, the sliding parts are not sufficiently lubricated, and are thus brought into a state in which metals are in direct contact with each other. At this time, friction due to this contact causes oxidization of the oil or occurrence of abrasion on an interface, thereby generating foreign material. For example, part of the bearing that falls off the bearing becomes foreign material.

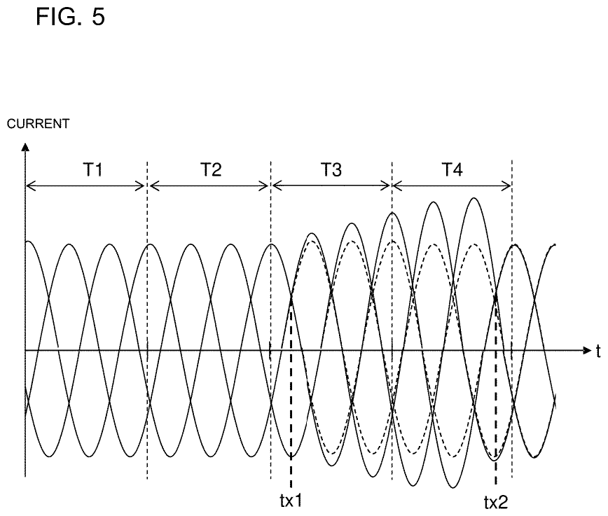

FIG. 5 illustrates an example of a current waveform in the case where an abnormality occurs in the motor. FIG. 5 illustrates an example of a current waveform that is detected in the case where foreign material is generated because of a contact between metals in the compressor 1. In a graph indicated in FIG. 5, the vertical axis represents a current that flows in the motor 12, and the horizontal axis represents an elapsed time t from a reference time. FIG. 5 indicates, on a time-series basis, a current that flows in the motor 12 each time the motor 12 completes one rotation. Specifically, FIG. 5 illustrates a current waveform of the motor 12 in the case where the motor 12 completes four rotations in a first rotation period T1 to a fourth rotation period T4 in this order from the reference time at which the elapsed time t=0.

Waveforms of the motor 12 in the first rotation period T1 to the fourth rotation period T4 are indicated by solid line. Waveforms of the motor 12 in the case where no abnormality occurs in the motor 12 in the third rotation period T3 and the fourth rotation period T4 are indicated by dotted lines. With reference to the third rotation period T3 and the fourth rotation period T4, the current indicated by the solid lines becomes higher at the elapsed time tx1 than the current waveform indicated by the dotted lines, and then changes back to the current waveform indicated by the dotted lines at the elapsed time tx2.

When foreign material generated due to a contact between metals is caught in a bearing of the compressor 1 or a sealing portion of the compression mechanism, a load torque increases and the current waveform temporarily increases until this foreign material passes through an area where it is caught or this foreign material is crushed. The current waveform from the elapsed time tx1 to the elapsed time tx2 indicated in FIG. 5 shows that the current waveform temporarily increases due to the foreign material. An event such as passing or crushing of foreign material occurs randomly. The magnitude of the load torque and the timing of generation thereof are ruleless.

As described above, the load torque generated due to foreign material is different in characteristics from a load torque generated due to the gas compression and gas pressure. To be more specific, a component that remains after separating, from the load torque of the motor 12, a torque component generated regularly due to the gas compression and a torque component generated due to the gas pressure that slowly changes, can be regarded as a torque generated due to foreign material. The torque generated due to foreign material will be hereinafter referred to as “abnormal torque.”

The amount of degradation of a sliding part of the compressor 1 is considered proportional to the amount of work due to the abnormal torque. In general, the work of the rotary body is defined by the formula “torque×rotation speed×time.” Thus, an abnormal work due to the abnormal torque described above can be calculated by the formula “abnormal torque×rotation speed×time.” The “work” is synonymous with the amount of power in terms of electricity. Thus, the amount of degradation of the sliding part of the compressor 1 can also be calculated by the expression “abnormal power×time.” The abnormal power is a value that is obtained by removing a component of power in the case where the compressor 1 operates normally, from the power of the motor 12. The value calculated by the expression “abnormal power×time” will hereinafter be referred to as an “amount of abnormal power.”

Based on the above principles, the power or work rate of the motor 12 is used as an index value for determination of whether the motor 12 has an abnormality or not to determine an abnormal work or an amount of abnormal power. As a result, it is possible to quantitatively observe the state of degradation of the compressor 1 provided with the motor 12. The following description concerning Embodiment 1 is made with respect to the case where the abnormality-index value extraction unit 25 determines the amount of abnormal power.

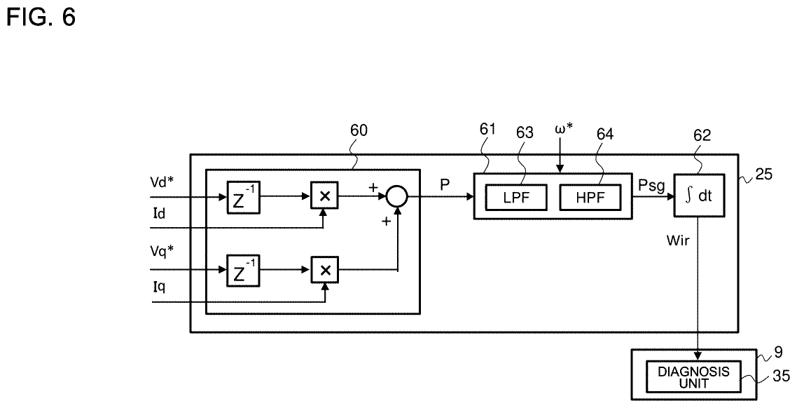

A configuration of the abnormality-index value extraction unit 25 as illustrated in FIG. 4 will be described below. FIG. 6 is a functional block diagram of the abnormality-index value extraction unit as illustrated in FIG. 4. The abnormality-index value extraction unit 25 includes an index value calculation unit 60, a filter unit 61, and an integrating unit 62. FIG. 6 illustrates a configuration example in which the abnormality-index value extraction unit 25 calculates a total change in abnormal power that occurs during a constant-speed operation of the motor 12.

The index value calculation unit 60 receives the voltage command value Vd* and the voltage command value Vq* that are sequentially input from the current control unit 31, and also receives the d-axis current Id and the q-axis current Iq that are sequentially input from the second coordinate conversion unit 33. The index value calculation unit 60 calculates an inner product of the voltage command value Vd* and the d-axis current Id and an inner product of the voltage command value Vq* and the q-axis current Iq, and calculates the sum of these inner products as an instantaneous power P. The index value calculation unit 60 transmits the calculated instantaneous power P to the filter unit 61.

The filter unit 61 receives an input of the speed command value ω*. The filter unit 61 includes a low-pass filter (LPF) 63 and a high-pass filter (HPF) 64. The LPF 63 removes from the instantaneous power P, a harmonic component based on a fundamental wave corresponding to the rotational frequency in a normal operating state of the motor 12. As a result, of the instantaneous power P, the amount of variation in torque that occurs when the compressor 1 performs compression operation in a normal operating state is attenuated. The HPF 64 removes a low frequency component in a normal operating state of the motor 12 from the instantaneous power P. As a result, of the instantaneous power P, the low frequency component which is a work component generated due to the gas pressure is attenuated.

The filter unit 61 monitors whether the speed command value ω* to be input changes or not, and this is input. When the speed command value ω* changes, the filter unit 61 removes a change in power that corresponds to the change in the speed command value ω*, from the instantaneous power P. Through the calculation process by the filter unit 61, a change in power in the normal operating state is removed from the instantaneous power P, and only an abnormal power component Psg is output from the filter unit 61. In this manner, the filter unit 61 performs a filtering process to remove a component in a normal operating state of the compressor 1 from the instantaneous power P that is input, thereby extracting the abnormal power component Psg.

When receiving an input of the abnormal power component Psg from the filter unit 61, the integrating unit 62 integrates the power component Psg with respect to time, thereby calculating an abnormal power amount Psgh. The integrating unit 62 transmits abnormality information Wir that is information indicating the abnormal power amount Psgh to a diagnosis unit 35 at regular intervals.

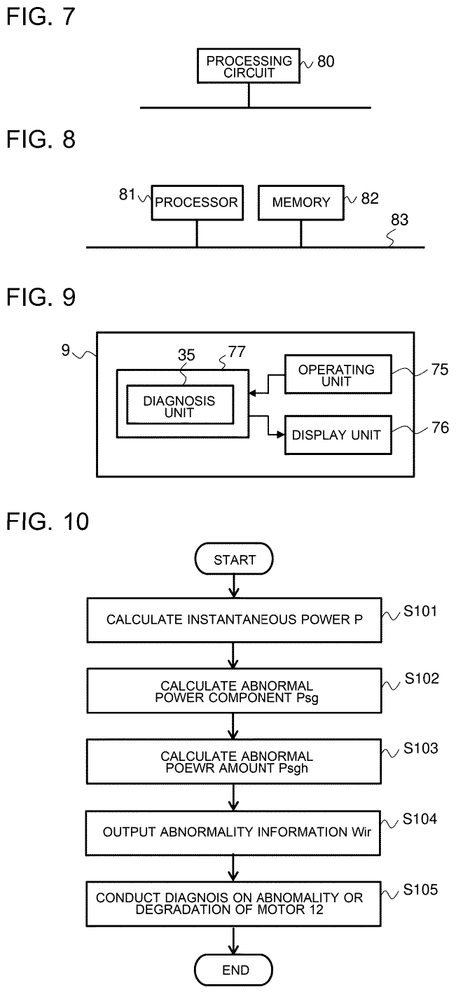

An example of hardware of the controller 23 as illustrated in FIG. 4 will be described. FIG. 7 is a hardware configuration diagram illustrating a configuration example of the controller as illustrated in FIG. 4. In the case where various functions of the controller 23 are fulfilled by hardware, the controller 23 as illustrated in FIG. 4 is a processing circuit 80 as illustrated in FIG. 7. The functions of the voltage command calculation unit 24 and the abnormality-index value extraction unit 25 as illustrated in FIG. 4 are fulfilled by the processing circuit 80.

In the case where the functions are fulfilled by hardware, the processing circuit 80 corresponds to, for example, a single-component circuit, a composite circuit, a programmed processor, a parallel-programmed processor, an application specific Integrated circuit (ASIC), a field-programmable gate array (FPGA), or a combination of those circuits. The functions of the voltage command calculation unit 24 and the abnormality-index value extraction unit 25 may be fulfilled by respective processing circuits 80 or may be fulfilled by a single processing circuit 80.

Another example of the hardware of the controller 23 as illustrated in FIG. 4 will be described. FIG. 8 is a hardware configuration diagram illustrating another configuration example of the controller as illustrated in FIG. 4. When various functions of the controller 23 are fulfilled by software, the controller 23 as illustrated in FIG. 4 includes a memory 82 and a processor 81 such as a central processing unit (CPU), as illustrated in FIG. 8. The functions of the voltage command calculation unit 24 and the abnormality-index value extraction unit 25 are fulfilled by the processor 81 and the memory 82. FIG. 8 illustrates the processor 81 and the memory 82 that are connected to each other by a bus 83 such that they can communicate with each other.

In the case where the functions are fulfilled by software, the functions of the voltage command calculation unit 24 and the abnormality-index value extraction unit 25 are fulfilled by software, firmware, or a combination of the software and the firmware. The software and the firmware are written as programs and stored in the memory 82. The processor 81 reads a program stored in the memory 82 and runs the program, thereby fulfilling an associated one of the functions of the units.

As the memory 82, a nonvolatile semiconductor memory is used that is, for example, a read only memory (ROM), a flash memory, an erasable and programmable ROM (EPROM), or an electrically erasable and programmable ROM (EEPROM). Alternatively, as the memory 82, a volatile semiconductor memory such as a random access memory (RAM) may be used. Furthermore, as the memory 82, a removable recording medium may be used that is a magnetic disc, a flexible disc, an optical disc, a compact disc (CD), a MiniDisc (MD), or a digital versatile disc (DVD).

Next, a configuration of the remote control 9 will be described. FIG. 9 is a block diagram illustrating a configuration example of the remote control. The remote control 9 includes an operating unit 75 such as a touch panel, a display unit 76 such as a liquid crystal display, and a control unit 77. The control unit 77 includes the diagnosis unit 35. A hardware configuration of the control unit 77 is the same as the configuration described with reference to FIGS. 7 and 8, and its detailed descriptions will thus be omitted.

When receiving the abnormality information Wir from the abnormality-index value extraction unit 25, the diagnosis unit 35 determines whether the abnormal power amount Psgh that is an integral value obtained as a result of a calculation made by the integrating unit 62 is larger than a predetermined first threshold th1 or not. When the abnormal power amount Psgh is larger than the first threshold th1, the diagnosis unit 35 determines whether the amount of change in the abnormal power amount Psgh per unit time is larger than a predetermined second threshold th2 or not. When the amount of change in the abnormal power amount Psgh is larger than the second threshold th2, the diagnosis unit 35 causes the display unit 76 to display information indicating that the abnormal power amount Psgh exceeds the second threshold th2.

When receiving the abnormality information Wir from the abnormality-index value extraction unit 25, the diagnosis unit 35 may cause the display unit 76 to display the abnormal power amount Psgh regardless of whether the abnormal power amount Psgh is larger than the first threshold th1. Furthermore, when the abnormal power amount Psgh is larger than the first threshold th1, the diagnosis unit 35 may cause the display unit 76 to display information indicating that the abnormal power amount Psgh is larger than the first threshold th1. When the abnormal power amount Psgh is larger than the first threshold th1, the diagnosis unit 35 may diagnose the motor 12 as having an abnormality or being degraded, and cause the display unit 76 to display information indicating that the motor 12 has an abnormality or the motor 12 is degraded, as the result of the diagnosis. In the case where the remote control 9 is provided with a voice output device (not illustrated), the diagnosis unit 35 may output the result of the diagnosis to the voice output device. In this case, the voice output device (not illustrated) outputs information on the result of the diagnosis through a speaker (not illustrated).

Regarding Embodiment 1, although the above description is made on the premise that the diagnosis unit 35 is provided in the remote control 9, the device in which the diagnosis unit 35 is provided is not limited to the remote control 9. The diagnosis unit 35 may be provided in the controller 23. A destination device to which the integrating unit 62 outputs the abnormality information Wir including the result of the calculation is not limited to the diagnosis unit 35.

For example, In the case where the refrigeration cycle apparatus 100 is provided with a display device (not illustrated), the integrating unit 62 may output the abnormality information Wir to the display device, and the display device may be caused to display the abnormal power amount Psgh. In the case where the refrigeration cycle apparatus 100 is provided with a voice output device (not illustrated), the integrating unit 62 may output the abnormality information Wir to the voice output device. In this case, the voice output device (not illustrated) outputs the value of the abnormal power amount Psgh indicated by the abnormality information Wir through a speaker (not illustrated).

Next, operation of the motor drive device 15 according to Embodiment 1 will be described. FIG. 10 is a flowchart indicating a procedure for the abnormal power-amount extracting method according to Embodiment 1.

First, the index value calculation unit 60 calculates an inner product of the voltage command value Vd* and the d-axis current Id and an inner product of the voltage command value Vq* and the q-axis current Iq, and calculates the sum of these inner products as the instantaneous power P (step S101). Subsequently, the LPF 63 in the filter unit 61 removes from the instantaneous power P, a harmonic component based on the rotational frequency in a normal operating state of the motor 12. The HPF 64 removes from the instantaneous power P, a low frequency component in the normal operating state of the motor 12. With this operation, of the instantaneous power P, a low frequency component that is a work component of gas pressure is attenuated. Accordingly, a torque variation that is made when the compressor 1 performs compression operation is attenuated. In this manner, the filter unit 61 removes the component in the normal operating state from the instantaneous power P and calculates the abnormal power component Psg (step S102).

In step S102, the filter unit 61 monitors whether the speed command value ω* changes or not. When the speed command value ω* changes, the filter unit 61 removes from the instantaneous power P, a change in power that corresponds to the change in the speed command value ω*. Through the above filtering process, the change in power in the normal operating state is removed from the instantaneous power P, and only the abnormal power component Psg is output from the filter unit 61. The filter unit 61 performs the filtering processing on the instantaneous power P in the above manner, whereby it is possible to extract the abnormal power component Psg from the instantaneous power P.

When receiving an input of the power component Psg from the filter unit 61 after the filtering processing is performed on the instantaneous power P, the integrating unit 62 integrates the power component Psg with respect to time, thereby calculating the abnormal power amount Psgh (step S103). The integrating unit 62 outputs the abnormality information Wir that is information on the abnormal power amount Psgh to the diagnosis unit 35 (step S104).

In the above manner, the abnormality-index value extraction unit 25 uses the voltage command values Vd* and Vq* and the d-axis current Id and the q-axis current Iq to determine the abnormal power amount Psgh, and then supplies information on the determined abnormal power amount Psgh to the diagnosis unit 35.

When receiving the abnormality information Wir from the integrating unit 62, the diagnosis unit 35 conducts a diagnosis of the motor 12 with respect to whether it has an abnormality or is degraded or not, based on the abnormal power amount Psgh (step S105). Specifically, the diagnosis unit 35 determines whether the abnormal power amount Psgh is larger than the first threshold th1 or not, and when the abnormal power amount Psgh is larger than the first threshold th1, the diagnosis unit 35 diagnoses the motor 12 as having an abnormality or being degraded. Then, the diagnosis unit 35 causes the display unit 76 to display, as the result of the diagnosis, information indicating that the motor 12 has an abnormality or is degraded. In contrast, when the abnormal power amount Psgh is less than or equal to the first threshold th1, the diagnosis unit 35 diagnoses the motor 12 as not having an abnormality or as not being degraded. In this case, the diagnosis unit 35 may cause the display unit 76 to display the result of the diagnosis that indicates that the motor 12 does not have an abnormality. It is also allowable that the diagnosis unit 35 does not cause the display unit 76 to display the result of the diagnosis.

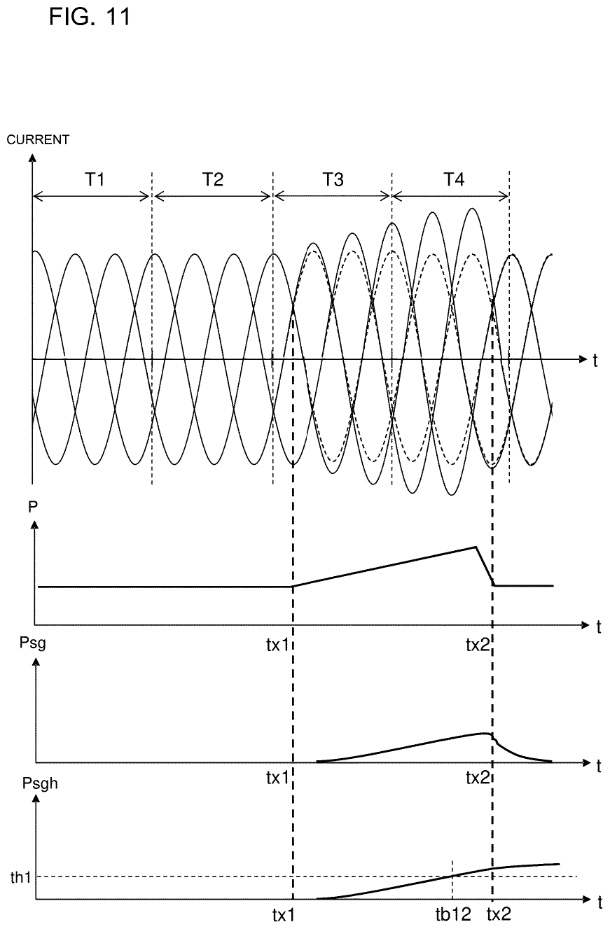

FIG. 11 indicates an example of the results of the processes of steps S101 to S103 indicated in FIG. 10. Of the graphs of FIG. 11, the highest graph indicates the current waveform illustrated in FIG. 5; the second highest graph indicates the instantaneous power P as the result of calculation by the index value calculation unit 60; the third highest graph indicates the power component Psg as the result of calculation by the filter unit 61; and the lowest graph indicates the abnormal power amount Psgh as the result of calculation by the integrating unit 62.

In the compressor 1, when an abnormality occurs, for example, in which part of a bearing falls off the bearing because of shortage of lubricant oil, the current waveform of the motor 12 increasers at the elapsed time tx1 as indicated in the highest graph of FIG. 11. The d-axis current Id and the q-axis current Iq are obtained by the d-q conversion that is performed on the above current waveform. An inner product of the d-axis current Id and the voltage command values Vd* and an inner product of the q-axis current Iq and the voltage command value Vq* are calculated to obtain the instantaneous power P converted to scalar quantity. The instantaneous power P starts increasing from the elapsed time tx1, and then suddenly decreases at the elapsed time tx2 to the level in the first rotation period T1 and the second rotation period T2.

In the instantaneous power P indicated in the second highest graph of FIG. 11, the DC amount is a load component generated in a normal operating state, and a harmonic is a pulsation component generated due to the gas compression. Thus, these components are removed from the instantaneous power P by the filter unit 61, and then only the abnormal power component Psg remains as indicated in the third highest graph of FIG. 11. Thereafter, when the integrating unit 62 integrates the abnormal power component Psg with respect to time, an abnormal power consumption is obtained as the abnormal power amount Psgh as illustrated in the lowest graph of FIG. 11.

After step S104 indicated in FIG. 10, when receiving the information on the abnormal power amount Psgh from the integrating unit 62, the diagnosis unit 35 causes the display unit 76 to display the information on the abnormal power amount Psgh. In this case, a user and a maintenance management personnel of the refrigeration cycle apparatus 100 can estimate the abnormal state or degradation state of the motor 12 or the compressor 1 based on a numerical value of the abnormal power amount Psgh displayed on the display unit 76.

After step S104 indicated in FIG. 10, when receiving the abnormality information Wir from the abnormality-index value extraction unit 25, the diagnosis unit 35 determines whether the abnormal power amount Psgh is larger than the first threshold th1 or not. At an elapsed time tb12 in the lowest graph of FIG. 11, the abnormal power amount Psgh increases larger than the first threshold th1. As the result of the determination, when the abnormal power amount Psgh is larger than the first threshold th1, the diagnosis unit 35 causes the display unit 76 to display information indicating that the abnormal power amount Psgh is larger than the first threshold th1. In this case, the user and the maintenance management personnel of the refrigeration cycle apparatus 100 can estimate that the greater the difference between the abnormal power amount Psgh determined larger than the first threshold th1 and the first threshold th1, the higher the degree of degradation or abnormality that occurs in the compressor 1.

Furthermore, after step S104 indicated in FIG. 10, when the abnormal power amount Psgh is larger than the first threshold th1, the diagnosis unit 35 determines whether the amount of change in the abnormal power amount Psgh is larger than the predetermined second threshold th2 or not. As the result of the determination, when the amount of change in the abnormal power amount Psgh is larger than the second threshold th2, the diagnosis unit 35 causes the display unit 76 to display information indicating that the amount of change in the abnormal power amount Psgh exceeds the second threshold th2. In this case, the user and the maintenance management personnel of the refrigeration cycle apparatus 100 can estimate that the motor 12 or the compressor 1 is in such an abnormal state or a degraded state that the compressor 1 needs to be subjected to maintenance.

The diagnosis unit 35 monitors the amount of change in the abnormal power amount Psgh at regular intervals, and thus enables the user and the maintenance management personnel of the refrigeration cycle apparatus 100 to know an abnormality that abruptly occurs in the compressor 1, and to thus determine the degree of the urgency of maintenance. The motor drive device 15 monitors the motor 12 and the compressor 1 in the above manner, whereby the user and the maintenance management personnel of the refrigeration cycle apparatus 100 can prevent a failure from suddenly occurring in the compressor 1 due to foreign material or other cause.

The abnormality-index value extraction unit 25 obtains the abnormal power amount Psgh in the motor 12 in the above manner, whereby the user and the maintenance management personnel of the refrigeration cycle apparatus 100 can estimate not only whether an abnormality occurs in the motor 12 or the compressor 1 or not, but also the mechanical degradation of the compressor 1.

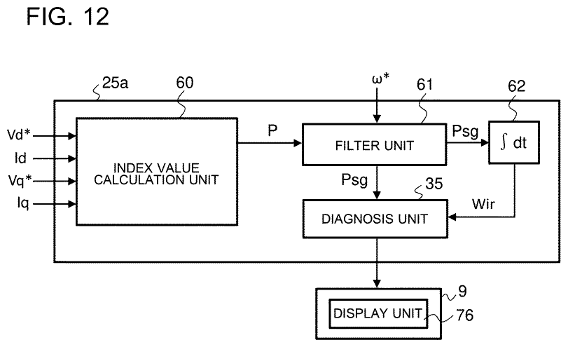

It should be noted that in Embodiment 1, the diagnosis unit 35 may be provided in the motor drive device 15. The diagnosis unit 35 may make a diagnosis of the motor 12 with respect to whether it has an abnormality or not or it is degraded or not, based on the abnormal power component Psg output from the filter unit 61. FIG. 12 is a functional block diagram illustrating another configuration example of the abnormality-index value extraction unit provided in the motor drive device according to Embodiment 1.

As illustrated in FIG. 12, an abnormality-index value extraction unit 25a includes the diagnosis unit 35. The diagnosis unit 35 conducts a diagnosis of the motor 12 with respect to whether the motor 12 has an abnormality or is degraded based on the abnormal power component Psg output from the filter unit 61. When receiving the abnormal power amount Psgh from the integrating unit 62, the diagnosis unit 35 conducts a diagnosis of the motor 12 with respect to whether the motor 12 has an abnormality or is degraded based on the abnormal power amount Psgh. That is, the diagnosis unit 35 may conduct a diagnosis of the motor 12 with respect to whether the motor 12 has an abnormality or is degraded based on the value of one or both of the abnormal power component Psg and the abnormal power amount Psgh.

The following description is made by referring to by way of example the case where the diagnosis unit 35 conducts a diagnosis of the motor 12, using one of two parameters that are the abnormal power component Psg and the abnormal power amount Psgh. The diagnosis unit 35 determines whether the abnormal power component Psg is larger than a predetermined abnormality determination threshold thd1 or not. When the abnormal power component Psg is larger than the abnormality determination threshold thd1, the diagnosis unit 35 diagnoses the motor 12 as having an abnormality or being degraded. In this case, the diagnosis unit conducts a diagnosis of the motor 12 with respect to whether it has an abnormality or is degraded before the abnormal power amount Psgh is calculated. This is an advantage. Furthermore, the diagnosis unit 35 determines whether the abnormal power amount Psgh included in the abnormality information Wir is larger than the first threshold th1 or not. When the abnormal power amount Psgh is larger than the first threshold th1, the diagnosis unit 35 diagnoses the motor 12 as having an abnormality or being degraded. In this case, even if noise is generated in the power P regardless of whether the motor 12 has an abnormality or is degraded, it is still possible to prevent the diagnosis unit 35 from making an incorrect diagnosis due to the noise, and the diagnosis unit 35 can more accurately make a diagnosis of the state of the motor 12, using a value calculated by integrating the abnormal power component Psg with respect to time.

Then, the following description is made by referring to by way of example the case where the diagnosis unit 35 conducts a diagnosis of the motor 12, using both two parameters that are the abnormal power component Psg and the abnormal power amount Psgh. The diagnosis unit 35 determines whether the abnormal power component Psg is larger than the abnormality determination threshold thd1 or not. Furthermore, the diagnosis unit 35 determines whether the abnormal power amount Psgh is larger than the first threshold th1 or not. When the abnormal power component Psg is larger than the abnormality determination threshold thd1, and the abnormal power amount Psgh is larger than the first threshold th1, then the diagnosis unit 35 diagnoses the motor 12 as having an abnormality or being degraded. In contrast, when the abnormal power amount Psgh is larger than the first threshold th1, but the abnormal power amount Psgh is smaller than or equal to the first threshold thd1, then the diagnosis unit 35 diagnoses the motor 12 as not having an abnormality or as not being degraded. The diagnosis unit 35 conducts a diagnosis of the motor 12 using the two parameters in the above manner, whereby it is possible to prevent the diagnosis unit 35 from making an incorrect diagnosis due to power noise generated in the motor 12, and the diagnosis unit 35 can more correctly make a diagnosis of the state of the motor 12 using the abnormal power amount Psgh.

When diagnosing the motor 12 as having an abnormality or being degraded, the diagnosis unit 35 transmits, as the result of the diagnosis, information indicating that the motor 12 has an abnormality or is degraded to the remote control 9. When receiving the result of the diagnosis from the diagnosis unit 35, the remote control 9 causes the display unit 76 to display information on the result of the diagnosis. By using the abnormal power component Psg, which is one of the above two parameters, for the diagnosis of the motor 12, it is possible to immediately notify the user of occurrence of an abnormality when the abnormality occurs in the motor 12. Furthermore, since the abnormal power amount Psgh is included in the parameters for use in the diagnosis, it is possible to more accurately notify the user of degradation or an abnormality that occurs in the motor 12. It should be noted that FIG. 12 illustrates an example of the configuration in which the diagnosis unit 35 is provided in the abnormality-index value extraction unit 25a; however, the diagnosis unit 35 may be provided at any other position in the motor drive device 15.

The motor drive device 15 of Embodiment 1 includes the index value calculation unit 60, the filter unit 61, and the diagnosis unit 35. The index value calculation unit 60 calculates the power P of the motor 12 as an index value for use in determination of whether an abnormality occurs in the motor 12 or not based on the motor current that is a current flowing in the motor 12 and the control parameter used in the feedback control of the motor 12. The filter unit 61 performs a filtering process to extract an abnormal component by removing a component that is in a normal operating state, from the power P calculated by the index value calculation unit 60. The diagnosis unit 35 conducts a diagnosis of the motor 12 regarding an abnormality in or degradation of the motor 12 based on the abnormal component of the power P.

In Embodiment 1, a diagnosis of the motor 12 regarding abnormality or degradation is conducted based on an abnormal component that is obtained as an index value that indicates an abnormality in the motor 12, after removing from the power P of the motor 12, a component that is in a normal operating state of the motor 12. Since a component corresponding to a change associated with the control of the motor 12 is removed from a monitoring value of the motor 12, it is possible to quantitatively know whether an abnormality occurs in the motor 12 or not and the degree of degradation of the motor 12. As a result, it is possible to accurately detect an abnormality in the motor 12 or the state of degradation of the motor 12.

In Embodiment 1, a diagnosis regarding abnormality or degradation may be conducted for the motor 12, using a value obtained by integrating, with respect to time, an abnormal component that is obtained as an index value that indicates an abnormality that occurs in the motor 12, after removing a component that is in a normal operating state of the motor 12 from the power P of the motor 12. Specifically, the power P is calculated from the motor current and the voltage command value, then an abnormal power consumption is extracted from the power P by the filter unit 61, and then a cumulative abnormal power consumption is calculated, thereby to obtain diagnostic information. In this manner, the component corresponding to the change associated with the control of the motor 12 is removed from a monitoring value of the motor 12, whereby it is possible to quantitatively know whether an abnormality occurs in the motor 12 or not and the degree of degradation of the motor 12. Thus, it is possible to accurately detect whether an abnormality occurs in the motor 12 or not, or the state of degradation of the motor 12. For example, it is possible to quantitatively detect an abnormality that occurs due to a minute foreign material that enters a space between a rotational portion and a stationary portion of the compressor 1, as the abnormal power amount Psgh. Accordingly, it is possible to quantitatively know whether an abnormality occurs or not in the compressor 1 and the degree of degradation of the compressor 1.

In Embodiment 1, when a phenomenon occurs in which the compressor 1 is mechanically degraded, a value that indicates the degradation or an abnormality can be quantitatively detected as the abnormal power amount Psgh, whereby it is possible to conduct a diagnosis regarding the degree of the degradation. As the phenomenon in which the compressor 1 is mechanically degraded, a phenomenon in which metals of the main shaft 45 of the motor 12 and the slide bearing are worn by their metallic contact, and a phenomenon in which foreign material that enters the compression mechanism is caught in the compressor 1.

From the viewpoint of maintenance of a system provided with the compressor 1, it is important to know the abnormal state of the compressor 1, that is, the degree of the degradation of the compressor 1, in order to recognize the degree of the urgency of the maintenance. If only the motor current is applied, it is not sufficient as a physical quantity that indicates the amount of mechanical damage in the compressor 1. In an existing method, it is impossible to estimate the degree of the degradation of the compressor 1. In contrast, according to Embodiment 1, a value obtained by integrating the abnormal power component Psg with respect to time is used as a physical quantity that indicates degradation of the compressor 1, whereby it is possible to quantitatively estimate the state of degradation of the compressor 1.

### Embodiment 2

The above description concerning Embodiment 1 is made with respect to the case where a power of the motor 12 is used as an index value that indicates an abnormality in the motor 12. The following description concerning Embodiment 2 is made with respect to the case where a mechanical work rate of the motor 12 is used as an index value that indicates an abnormality in the motor 12. Regarding Embodiment 2, components that have the same configurations as those described regarding Embodiment 1 will be denoted by the same reference signs, and their detailed descriptions will thus be omitted. Furthermore, regarding Embodiment 2, detailed descriptions of configurations and operations, which are descried above regarding Embodiment 1, will be omitted.

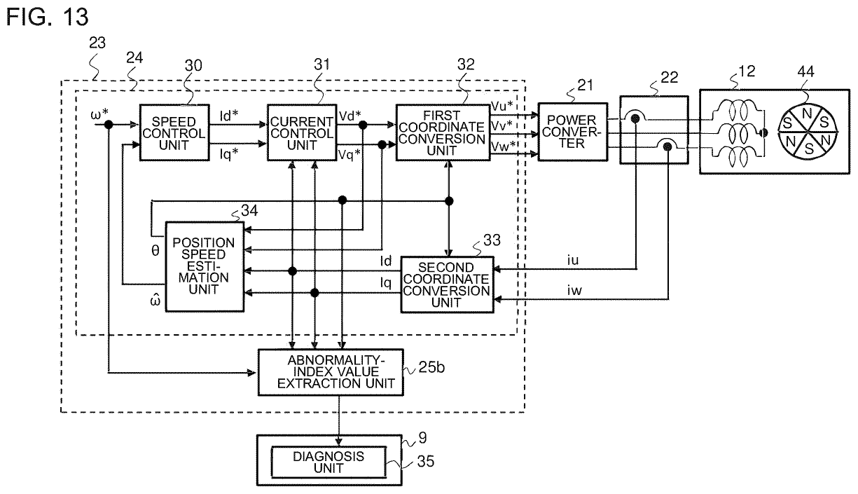

A configuration of the motor drive device according to Embodiment 2 will be described below. FIG. 13 is a functional block diagram illustrating a configuration example of a controller provided in a motor drive device according to Embodiment 2. The controller 23 as illustrated in FIG. 13 is provided in the motor drive device 15 in the refrigeration cycle apparatus 100 as illustrated in FIG. 1.

As illustrated in FIG. 13, the controller 23 includes the voltage command calculation unit 24 and an abnormality-index value extraction unit 25b. The abnormality-index value extraction unit 25b receives an input of the speed command value ω* from the controller 8, an input of the phase θ that indicates an estimated position of the rotor 44 from the position speed estimation unit 34, and inputs of the d-axis current Id and the q-axis current Iq from the second coordinate conversion unit 33. The abnormality-index value extraction unit 25b calculates an abnormal work based on the d-axis current Id, the q-axis current Iq, and the phase θ.

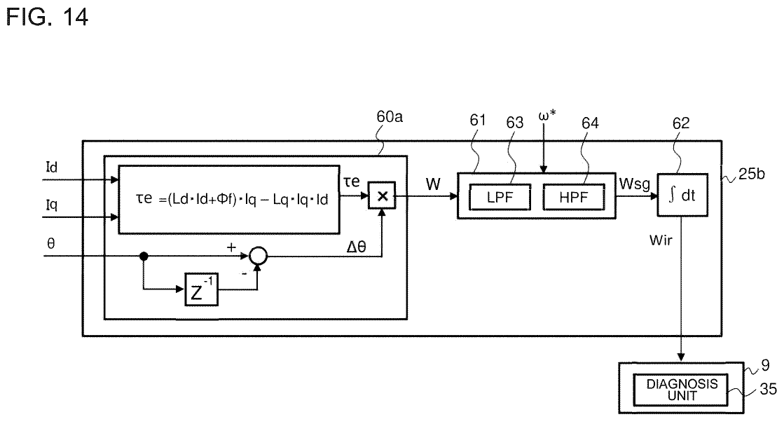

FIG. 14 is a functional block diagram of the abnormality-index value extraction unit as illustrated in FIG. 13. The abnormality-index value extraction unit 25b includes an index value calculation unit 60a, the filter unit 61, and the integrating unit 62. The index value calculation unit 60a calculates a work rate W of the motor 12 in the following manner. First, the index value calculation unit 60a calculates an estimated value re of output torque, using the following equation (1).

$$τ e = ( Ld \times Id + Φ f ) \times Iq - Lq \times Iq \times Id \qquad ( 1 )$$

$$τ m = Pp \times τ e \qquad ( 2 )$$

$$Δθ m = Δθ / Pp \qquad ( 3 )$$

In the equation (1), ϕf is a magnetic flux of the permanent magnet of the motor 12, Ld is a d-axis inductance, and Lq is a q-axis inductance. The index value calculation unit 60a stores values of ϕf, Ld, and Lq in advance. It should be noted that the output torque τe in the equation (1) is a physical quantity referred to as electrical torque and corresponds to an electrical frequency and an electrical phase of an inverter output. Where τm is the mechanical torque, the relationship between the mechanical torque τm and the electrical torque re is expressed by using the number of pole pairs Pp of the motor as indicated by the equation (2). In Embodiment 2, the work rate W is calculated using an electrical physical quantity; however, the work rate W may be calculated using a mechanical physical quantity. In this case, it suffices that a mechanical rotation angle Δθm is calculated based on the equation (3), and the work rate W is determined by multiplying the calculated mechanical rotation angle Δθm by the mechanical torque rm.

The index value calculation unit 60a calculates an estimated value Δθ of a rotation angle that is an amount of change from the phase θ indicating an estimated position and received at the time of calculating the work rate W last time, to the phase θ indicating an estimated position and received at the time of calculating the work rate W this time. Then, the index value calculation unit 60a calculates the product of the estimated value re of output torque and the estimated value Δθ of the rotation angle, thereby calculating the work rate W.

The filter unit 61 performs a filtering process in which a component that is in a normal operating state of the compressor 1 is removed from the work rate W, thereby extracting an abnormal work rate component Wsg. The filter unit 61 transmits the abnormal work rate component Wsg to the integrating unit 62. When receiving an input of the abnormal work rate component Wsg from the filter unit 61, the integrating unit 62 integrates the work rate component Wsg with respect to time, thereby calculating an abnormal work Wsgh. The integrating unit 62 transmits the abnormality Information Wir that is information indicating the abnormal work Wsgh to the diagnosis unit 35 at regular intervals.

It should be noted that the motor drive device 15 of Embodiment 2 operates according to the same operation procedure as described with reference to FIG. 10 regarding Embodiment 1, except for use of a different type of abnormality index value, and its detailed descriptions will thus be omitted.

In Embodiment 2, the abnormality-index value extraction unit 25b determines the abnormal work Wsgh of the motor 12, whereby the user and the maintenance management personnel of the refrigeration cycle apparatus 100 can estimate not only whether an abnormality occurs in the motor 12 or the compressor 1 or not, but also the mechanical degradation of the compressor 1.

The above descriptions regarding Embodiments 1 and 2 are made with respect to the case where the diagnosis unit 35 is provided in the remote control 9; however, the device where the diagnosis unit 35 is provided is not limited to the remote control 9. The diagnosis unit 35 may also be provided in the controller 8 as illustrated in FIG. 1. Alternatively, the diagnosis unit 35 may be provided in an apparatus separate from the refrigeration cycle apparatus 100.

### Modification 1

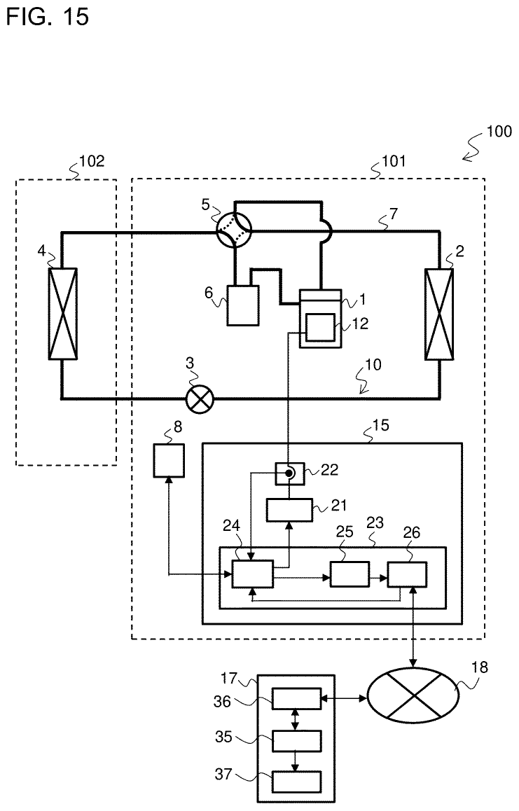

Modification 1 relates to a refrigeration cycle system provided with the refrigeration cycle apparatus 100 according to Embodiment 1 or 2. FIG. 15 illustrates a configuration example of the refrigeration cycle system of Modification 1. The following description regarding Modification 1 is made with respect to the case where the refrigeration cycle system is provided with the refrigeration cycle apparatus 100 according to Embodiment 1. The refrigeration cycle system may be provided with the refrigeration cycle apparatus 100 according to Embodiment 2.

As illustrated in FIG. 15, the diagnosis unit 35 is provided in an information processing terminal 17 connected to a network 18. The network 18 is, for example, the Internet. The information processing terminal 17 is, for example, an information processing terminal such as a smartphone or a tablet terminal. The user or the maintenance management personnel of the refrigeration cycle apparatus 100 carries the information processing terminal 17. The information processing terminal 17 includes the diagnosis unit 35, a communication unit 36 through which the diagnosis unit 35 is connected to the network 18, and a display unit 37. The display unit 37 is, for example, a liquid crystal display. The diagnosis unit 35 is provided in a controller (not illustrated).

The controller 23 includes a communication unit 26 through which the controller 23 communicates with the information processing terminal 17 via the network 18. The communication unit 26 transmits to the voltage command calculation unit 24, information received from the diagnosis unit 35 through the communication units 26 and 36. The communication units 26 and 36 are communication circuits that transmit and receive data to and from each other according to, for example, the Internet protocol (IP) communications standards.

Regarding the refrigeration cycle system of Modification 1, only different operations from the operations described regarding Embodiment 1 will be described below. When the abnormal power amount Psgh is larger than the first threshold th1, the diagnosis unit 35 determines whether the amount of change in the abnormal power amount Psgh is larger than the second threshold th2 or not. As the result of the determination, when the amount of change in the abnormal power amount Psgh is larger than the second threshold th2, the diagnosis unit 35 transmits information indicating that the upper limit of the operating frequency of the compressor 1 should be reduced to the communication unit 26 through the communication unit 36. When receiving the information indicating that the upper limit of the operating frequency of the compressor 1 should be reduced, from the information processing terminal 17, the communication unit 26 transfers the information indicating that the upper limit of the operating frequency of the compressor 1 should be reduced to the voltage command calculation unit 24.

When receiving the information indicating that the upper limit of the operating frequency of the compressor 1 should be reduced, from the diagnosis unit 35 through the communication unit 26, the voltage command calculation unit 24 sets the upper limit of the operating frequency of the compressor 1 to a value smaller than a predetermined maximum value. As a result, when an abnormality occurs in the motor 12 or the compressor 1, it is possible to reduce the likelihood that the degradation of the compressor 1 will progress, and thus can prevent operation of the refrigeration cycle apparatus 100 from being stopped before the maintenance management personnel performs maintenance on the compressor 1.

In Modification 1, from an apparatus separate from the refrigeration cycle apparatus 100, the diagnosis unit 35 remotely monitors the state of degradation of the motor 12 or the compressor 1 through the communication unit 36, whereby it is possible to reduce the number of times regular maintenance of the compressor 1 is performed, and thus reduce the workload on maintenance personnel.

The above descriptions regarding Embodiments 1 and 2 and Modification 1 are made with respect to the case where the integrating unit 62 is provided in the motor drive device 15 in the refrigeration cycle apparatus 100; however, they are not limiting. The integrating unit 62, as well as the diagnosis unit 35, may be provided in an apparatus separate from the refrigeration cycle apparatus 100. For example, the integrating unit 62 may be provided in the information processing terminal 17 as Illustrated in FIG. 15. In this case, the load on the calculation process by the controller 23 is reduced.

### REFERENCE SIGNS LIST

1: compressor, 2: heat-source-side heat exchanger, 3: expansion device, 4: load-side heat exchanger, 5: four-way valve, 6: accumulator, 7: refrigerant pipe, 8: controller, 9: remote control, 10: refrigerant circuit, 12: motor, 13: DC voltage source, 15: motor drive device, 17: information processing terminal, 18: network, 20: inverter, 21: power converter, 22: current sensor, 23: controller, 24: voltage command calculation unit, 25, 25a, 25b: abnormality-index value extraction unit, 26: communication unit, 30: speed control unit, 31: current control unit, 32: first coordinate conversion unit, 33: second coordinate conversion unit, 34: position speed estimation unit, 35: diagnosis unit, 36: communication unit, 37: display unit, 40: stationary scroll, 41: orbiting scroll, 42: power terminal, 43: stator, 44: rotor, 45: main shaft, 46: main shaft eccentric portion, 47: suction pipe, 48: discharge port, 49: discharge pipe, 50: main bearing, 51: sub-bearing, 52: hermetic container, 54: oil pump, 60, 60a: index value calculation unit, 61: filter unit, 62: integrating unit, 63: low-pass filter, 64: high-pass filter, 71a to 73a, 71b to 73b: switching element, 75: operating unit, 76: display unit, 77: control unit, 80: processing circuit, 81: processor, 82: memory, 83: bus, 100: refrigeration cycle apparatus, 101: heat-source-side unit, 102: load-side unit

1. A motor drive device that performs a feedback control of a motor based on a motor current that is a current flowing in the motor, the motor drive device comprising:
a controller configured to calculate power or a work rate of the motor as an index value for use in determining whether an abnormality occurs in the motor or not based on the motor current and a control parameter used in the feedback control, the controller including a filter configured to perform a filtering process to extract an abnormal component by removing a component that is in a normal operating state, from the calculated index value, the controller being configured to conduct a diagnosis of the motor regarding an abnormality or degradation thereof based on the abnormal component of the index value,
the filter including
a low-pass filter configured to remove from the index value, a harmonic component based on a fundamental wave corresponding to a rotational frequency in a normal operating state of the motor, and
a high-pass filter configured to remove from the index value, a low frequency component in the normal operating state of the motor.

2. The motor drive device of claim 1, wherein the controller is configured to
integrate the abnormal component of the index value with respect to time, and
conduct the diagnosis of the motor regarding the abnormality or degradation thereof based on one or both of the abnormal component of the index value and an integral value that is a result of calculation by the integration.

3. The motor drive device of claim 1, comprising an inverter configured to supply power to the motor,
wherein the controller is configured to calculate an inner product of the motor current and a voltage command value, thereby calculating power of the motor, the voltage command value being the control parameter input to the inverter.

4. The motor drive device of claim 1, comprising an inverter configured to supply power to the motor,
wherein the controller is configured to
calculate an estimated value of torque of the motor, using a predetermined equation including the motor current,
calculate an estimated value of a rotation angle of the motor from the motor current and an amount of change in an estimated position of a rotor of the motor that is based on a voltage command value, and
calculate a product of the estimated value of the torque and the estimated value of the rotation angle, thereby calculating the work rate, the voltage command value being the control parameter input to the inverter.

5. (canceled)

6. The motor drive device of claim 1, wherein the filter is configured to remove from the index value, a component corresponding to a change in a speed command value for the motor.

7. The motor drive device of claim 1, wherein
a load of the motor is a compressor in which a rotational shaft of the motor is supported by a slide bearing, and
the controller is configured to output a result of the diagnosis to an external device.

8. A refrigeration cycle apparatus comprising:
a refrigerant circuit including a compressor in which a motor is provided; and
the motor drive device of claim 1, the motor drive device being configured to drive the motor.

9. A refrigeration cycle system comprising:
a refrigerant circuit including a compressor in which a motor is provided;
a power converter including an inverter configured to supply power to the motor; and
a controller configured to perform a feedback control of the motor through the inverter, based on a motor current that is a current flowing in the motor, and calculate power or a work rate of the motor as an index value for use in determining whether an abnormality occurs in the motor or not based on the motor current and a control parameter used in the feedback control,
wherein
the controller includes a filter configured to perform a filtering process to extract an abnormal component by removing a component in a normal operating state from the calculated index value, and the controller is configured to conduct a diagnosis of the motor regarding an abnormality or degradation thereof based on the abnormal component of the index value, and
the filter includes
a low-pass filter configured to remove from the index value, a harmonic component based on a fundamental wave corresponding to a rotational frequency in a normal operating state of the motor, and
a high-pass filter configured to remove from the index value, a low frequency component in the normal operating state of the motor.

10. The refrigeration cycle system of claim 9, comprising a display unit connected to the controller,
wherein the controller is configured to determine whether a value of the abnormal component is greater than a predetermined abnormality determination threshold or not, and cause the display unit to display information indicating that an abnormality occurs in the motor or the motor is degraded, when the value of the abnormal component is greater than the abnormality determination threshold.

11. The refrigeration cycle system of claim 9, comprising:
a display unit connected to the controller,
wherein the controller is configured to
integrate the abnormal component of the index value with respect to time,
determine whether an amount of change in the integral value is larger than a predetermined second threshold or not, when an integral value that is a result of calculation performed by the integration is greater than a predetermined first threshold, and
cause the display unit to display information indicating that the amount of change is larger than the second threshold, when the amount of change is larger than the second threshold.

12. The refrigeration cycle system of claim 11, wherein the controller is configured to reduce an upper limit of an operating frequency of the compressor, when the amount of change is larger than the second threshold.

13. The motor drive device of claim 1, wherein
a load of the motor is a compressor in which a rotational shaft of the motor is supported by a slide bearing,
the filter is configured to remove, using the low-pass filter, the harmonic component that is a pulsation component generated by gas compression in the compressor, from the index value, and remove, using the high-pass filter, the low frequency component that is a work component generated by a gas pressure in the compressor, from the index value, thereby extracting an abnormal torque generated by foreign material that enters a gap between a rotational portion and a stationary portion of the motor, and
the controller is configured to conduct the diagnosis of the motor regarding the abnormality or degradation thereof based on an abnormal power mount calculated from the abnormal torque.

14. The refrigeration cycle system of claim 9, wherein
the filter is configured to remove, using the low-pass filter, the harmonic component that is a pulsation component generated by gas compression in the compressor, from the index value, and remove, using the high-pass filter, the low frequency component that is a work component generated by a gas pressure in the compressor, from the index value, thereby extracting an abnormal torque generated by foreign material that enters a gap between a rotational portion and a stationary portion of the motor, and
the controller is configured to conduct the diagnosis of the motor regarding the abnormality or degradation thereof based on an abnormal power mount calculated from the abnormal torque.
